(19) United States
(12) Patent Application Publication
(10) Pub. No.: US 2008/0008534 A1
(43) Pub. Date: Jan. 10, 2008

(54) Method of rehabilitating soil and/or underground water, and equipment for implementing the method

(76) Inventors: Christian Ille, Nanterre (FR); Jean-Jacques Kachrillo, Nanterre (FR)

Correspondence Address: KENYON & KENYON LLP, 1500 K STREET N.W., SUITE 700, WASHINGTON, DC, 20005, US

(21) Appl. No.: 11/730,830

(22) Filed: Apr. 4, 2007

(30) Foreign Application Priority Data
Apr. 6, 2006 (FR) 0651241

(51) Int. Cl. E21B 7/26; B09C 1/08; B09C 1/10

(52) U.S. Cl. 405/128.5; 175/19

(57) ABSTRACT

The invention relates to a method of rehabilitating soil and/or underground water in a volume of polluted soil. The method comprises the following steps: moving a boring tool in the volume, the tool being suitable for cutting up the soil and mixing it uniformly in said volume; and simultaneously with the mixing, injecting a treatment agent into the soil mixed with said tool, so that said treatment agent is dispersed uniformly in the volume, said treatment agent comprising at least one of the following agents: a gaseous fluid that is not solely chemically reactive; a chemically reactive agent constituted by a chemical substance that is oxidizing, reducing, or neutralizing; and a reactive agent constituted by a population of microorganisms or by a microorganism culture medium; whereby the soil and/or underground water is/are rehabilitated in situ.

The present invention provides a method of rehabilitating soil and/or underground water in a volume of polluted soil, and to equipment for implementing the method.

### BACKGROUND OF THE INVENTION

The treatment of soil or underground water suffering from organic and metallic pollution of natural or man-made origin and presenting a level of danger that is judged to be unacceptable is generally performed either in situ or out of the ground.

Treatment out of the ground takes place after a stage during which the polluted water table or the polluted soil is extracted. The treatment stage requires implementing physical, chemical, or biological treatment methods out of the ground (on site or off site). Extracting polluted underground water or polluted soil presents special difficulties such as controlling selective extraction of pollutants. The pollutants present in the subsoil are diluted either on coming into contact with the soil by adsorption, whereupon they travel downwards under gravity, or else in underground water, where they move by convection and diffusion (variation in space and in time). This results in a quantity of polluted materials in liquid or solid form that can sometimes be very large, thus making extraction operations technically difficult to perform, lengthy, and expensive.

### OBJECTS AND SUMMARY OF THE INVENTION

Given the problems that arise when treating polluted soil out of the ground, a first object of the invention is to provide a method of rehabilitating soil and/or underground water in a volume of polluted soil that is performed in situ and that presents the same effectiveness as treatments performed out of the ground but at a cost that is smaller.

According to the invention, to achieve this object, the method of rehabilitating soil and/or underground water in a volume of polluted soil comprises the following steps:
displacing a boring tool in said volume, the tool being suitable for cutting up the soil and mixing it uniformly in said volume; said boring tool being selected from the group comprising boring tools having a horizontal axis of rotation associated with vertical displacement, and boring tools having cutter elements that move substantially vertically, with the displacement of the tool being horizontal; and simultaneously with the mixing;
injecting a treatment agent into the soil mixed by means of said tool, such that during the mixing said treatment agent is dispersed uniformly in the volume, said treatment agent comprising at least one of the following agents suitable for acting on the polluting elements:
   a gaseous fluid that is not solely chemically reactive;
   a chemically reactive agent constituted by a chemical substance that is oxidizing, reducing, or neutralizing; and
   a reactive agent constituted by a population of microorganisms or a microorganism culture medium;

thereby enabling the soil and/or the underground water to be rehabilitated in situ.

It will be understood that by moving in the volume that is to be treated, the cutter tool that is suitable for mixing the soil uniformly and that serves simultaneously for injecting a treatment agent into the mixed soil so that during mixing the treatment agent is dispensed uniformly within the volume, it is possible within the volume to obtain close contact between the treatment agent and the soil or the water to be treated, and thus obtain treatment that is effective.

This mixing of the cut-up soil and this effective mixing with the treatment agent is obtained in particular because of the types of cutting tool used.

In addition, because the tool moves, it is possible to treat volumes of soil that are relatively large.

In a first implementation of the method, the displacement of the tool is vertical and the cutter elements are rotary about horizontal axes. This produces a treated volume of soil that is in the form of a rectangular parallelepiped and of a depth that can be relatively large.

In a second implementation, the movement of the displacement tool is horizontal and the cutter elements are moved substantially vertically. In this implementation, it is possible to treat the soil over a length that is relatively long, but over a depth that is not so deep.

In both cases, the treated volume of soil is substantially in the form of a rectangular parallelepiped or of a plurality of interconnected rectangular parallelepipeds.

Preferably, a sealing bell is placed over the surface of the ground in register with the zone being treated in order to recover the gas escaping from the soil.

The invention also provides equipment for rehabilitating the soil and/or underground water in a polluted volume of soil, particularly but not exclusively by implementing the above-defined method.

According to the invention, the equipment for rehabilitating soil and/or underground water in a volume of polluted soil comprises:
a machine fitted with a boring tool for cutting into said volume of soil and mixing the soil in uniform manner within said volume, said tool further including means for injecting a treatment agent in such a manner that during the mixing, said treatment agent is dispersed uniformly within the volume;
means for feeding said injection means with the treatment agent;
means for displacing said boring tool; and
sealing bell-forming means suitable for being placed on the surface of the ground in register with the soil being treated with the boring tool, said boring tool being selected from the group comprising boring tools having a horizontal axis of rotation and for moving vertically, and boring tools having cutter elements that move substantially vertically, the movement of the tool being horizontal.

Preferably, when the treatment agent is gaseous, said bell further includes means for drawing off the gas escaping from the zone of terrain being treated.

In a first embodiment, said boring tool comprises two pairs of horizontal-axis rotary cutters.

In a second embodiment, said cutter element of the boring tool is a substantially vertical endless chain carrying cutter teeth.

### BRIEF DESCRIPTION OF THE DRAWINGS

Other characteristics and advantages of the invention appear better on reading the following description of various implementations of the invention given as non-limiting examples. The description refers to the accompanying figures, in which:

FIG. 1 shows the use of a first boring tool for implementing the treatment method when the treatment agent used is a gas;

FIG. 2 shows the use of the same boring tool when the treatment agent is a chemical substance;

FIG. 3 shows the use of a second type of boring type when the treatment agent is a gas; and

FIG. 4 shows the use of the second type of boring tool when the treatment agent is a chemical substance.

### MORE DETAILED DESCRIPTION

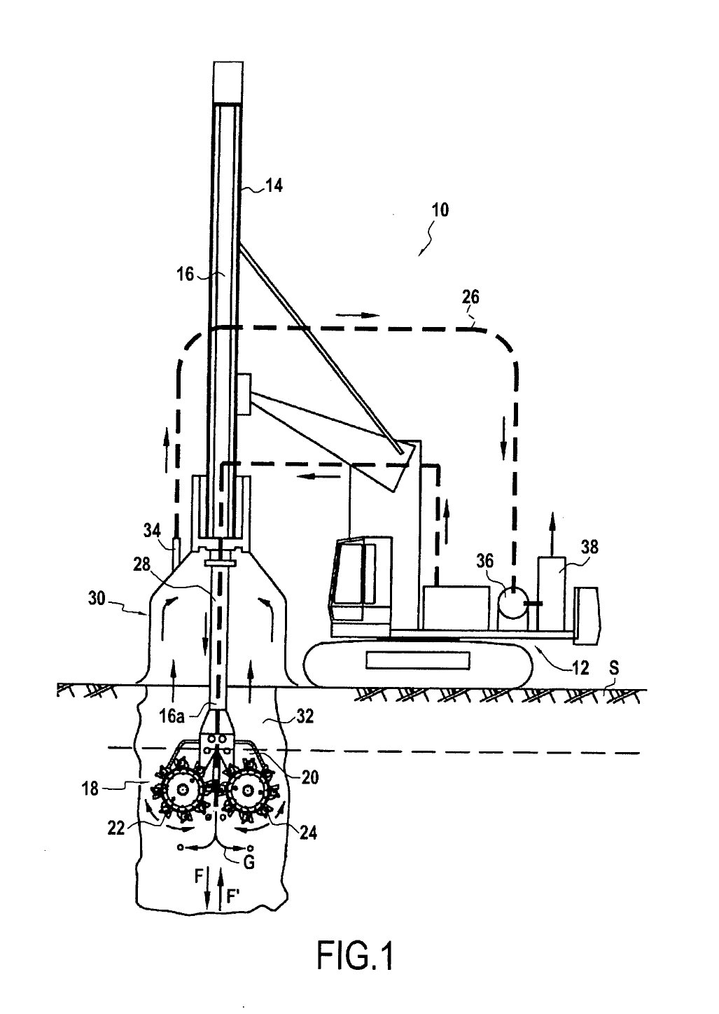

With reference initially to FIG. 1, there follows a description of first equipment for implementing the treatment method when the displacement of the boring tool is vertical and the treatment agent is a gas.

The equipment 10 comprises a tracked carrier 12 standing on the surface of the ground S. The carrier supports a vertical guide mast 14 for vertically moving a guide bar 16. At the bottom end 16a of the guide bar there is secured the boring tool proper 18. In this first embodiment, the boring tool 18 essentially comprises a support structure 20 and two pairs of rotary cutters 22 and 24 having parallel axes that are horizontal. Under the effect of movements of the guide bar 16, the tool 18 can be moved vertically upwards or downwards as represented by arrows F and F′. The equipment also comprises pipes 26 for feeding treatment gas. These pipes are extended in the guide bar 18 by tubes 28 that are terminated by injection nozzles mounted on the support 20 of the tool 18 and represented by arrow G in FIG. 1. Preferably, there are a plurality of nozzles in order to obtain more uniform injection into the mixed soil. These nozzles are disposed at least at the bottom portion of the support 20 between the pairs of cutters. The equipment also has a sealing bell or skirt 30 which is disposed on the surface of the ground S over the zone of the soil 32 that is being treated. This sealing skirt is suspended by a part 34 from the guide mast 14.

The up and down movements of the tool serve to bore a volume of substantially rectilinear section and of depth that can be relatively great. The cutters 22, 24 serve not only to cut up the soil but also to mix it. Simultaneous injection of the treatment gas makes it possible, while suitably controlling the travel of the tool 18, to put the cut-up and mixed soil into intimate contact with the treatment gas so as to obtain uniform contact for all of the cut-up soil. The sealing skirt or bell 30 is also provided towards its top end with an extraction orifice 24 for recovering the gas that escapes from the volume into which it is injected. The extraction orifice 34 is connected to an air extractor 36 and to a filter 38 that serves to retain the pollution extracted by the treatment gas and to encourage exhausting purified air into the atmosphere.

The gas used may be a gas that is not solely chemically reactive, such as air, nitrogen, or rare gases. The gas causes volatile organic compounds present in adsorbed form on the solid matrix and in liquid or dissolved form in underground water to be transferred to the gaseous phase, which is then extracted from the subsoil via the extraction orifice 34. This serves to “strip” the soil, i.e. to remove therefrom the volatile organic compounds that pollute it.

The treatment gas may also be a gas that is chemically active, being an oxidizing, reducing, or neutralizing agent so as to cause the pollution present in the soil to be transformed into a substance that is not dangerous. The gas may be ozone or chlorine.

Naturally, in this implementation, the carrier 12 enables a plurality of adjacent vertical displacements of the tool to be performed so as to treat a plurality of juxtaposed zones generally in the form of rectangular parallelepipeds.

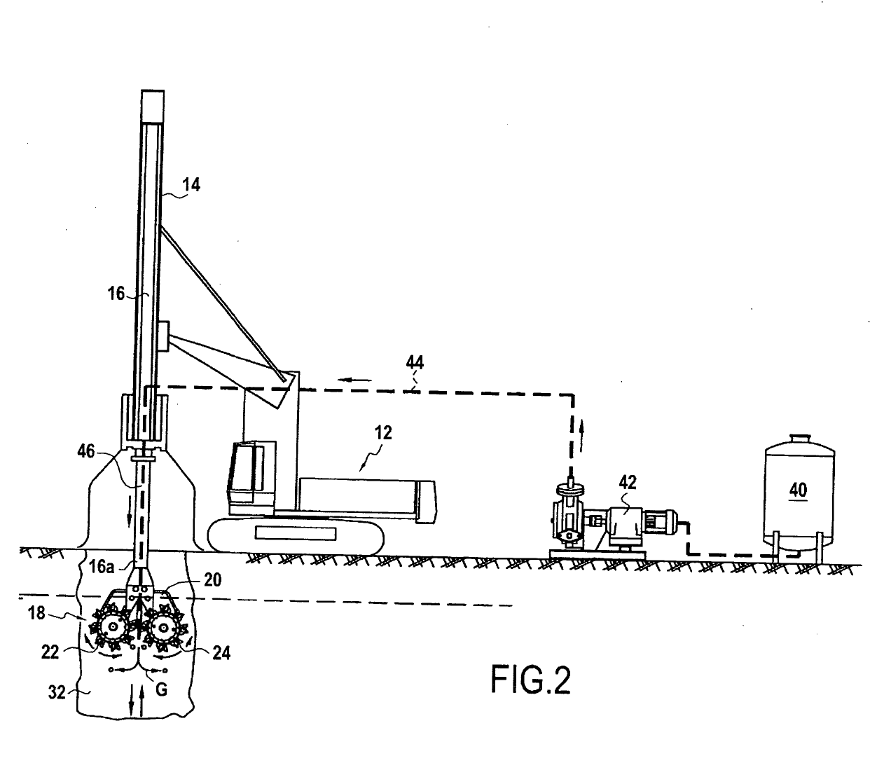

FIG. 2 shows a second use of the same boring tool for treating soil or underground water using a treatment agent that is liquid. For this purpose, the installation further includes a tank 40 for storing the chemical substance, an injector pump 42 for transmitting the treatment liquid under pressure via the pipe 44 to the feed pipe 46 formed in the guide bar 16. Naturally, there is no need to provide a system for extracting gas. The treatment agent may also be constituted by a population of microorganisms contained in a suitable liquid or a culture medium for such microorganisms. The “bioreactor” implemented in this way in the soil enables the purifying microorganisms to be put into direct contact with the polluting substances in situ.

This tool is well adapted to circumstances in which the volume of terrain to be treated presents a depth that is relatively great, since it is easy to use a guide bar adapted to the depth of the terrain to be bored and treated.

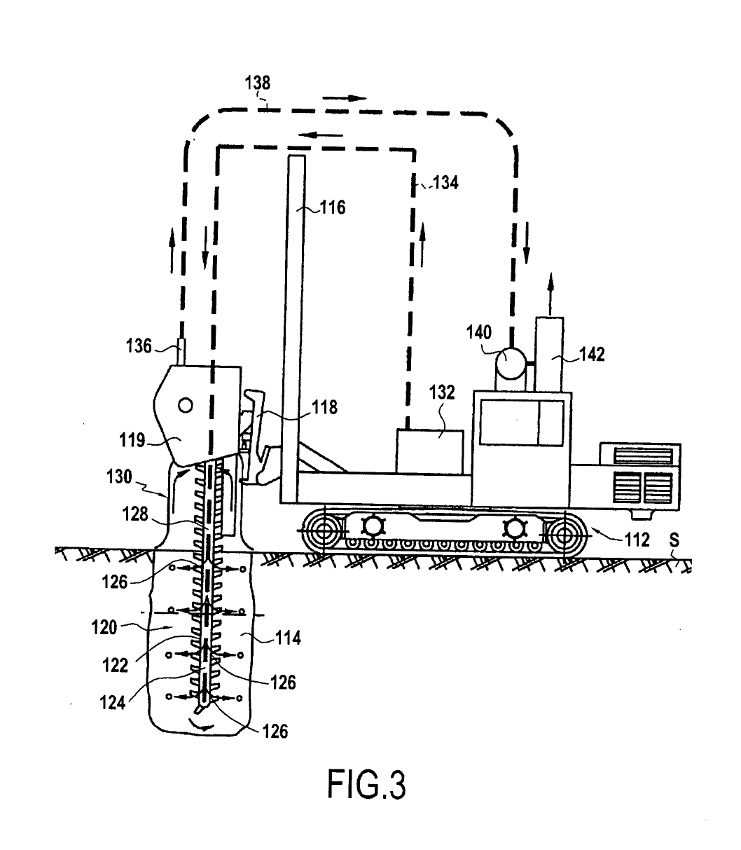

FIG. 3 shows an implementation of the method in which a boring tool is used for moving horizontally and in which the treatment agent is a gas.

In this figure, there can be seen the carrier 112 standing on the ground S close to the zone 14 that is being treated. The carrier 112 supports a vertical guide mast 116 along which a carriage 118 can move, which carriage has mounted thereon a head 119 for driving a cutter tool 120. By way of example, the cutter tool 120 for horizontal displacement is constituted by an endless chain 122 that is substantially vertical and driven by the drive head 119. The endless chain 122 carries teeth whose substantially vertical travel serves to cut up and mix the soil. The support 124 for the endless chain is fitted with injection nozzles 126 that are regularly distributed for injecting the treatment gas and that are fed by the pipe 128. The equipment likewise includes a sealing bell or skirt 130 that is disposed at the surface of the ground in register with the zone 114 that is being treated. By way of example, this skirt 130 is suspended from the drive head 119. The equipment naturally includes a compressor 132 for circulating the treatment gas under pressure, which gas is taken via the pipe 134 to the pipe 128 for feeding the cutter tool 122. The sealing skirt 130 is likewise associated with an extractor orifice 136 connected to an extraction pipe 138, itself connected to an air extractor 140. The air extractor 140 is connected to a filter 142 enabling air that has been cleaned of its pollutants to be exhausted to the atmosphere.

During an initial stage, the cutter tool 120 is lowered down the mast 116 so as to bore, mix, and inject gas into an initial volume 114. Thereafter, with the tool 120 being maintained in its vertical engagement position as shown in FIG. 3, it is moved horizontally in the direction of arrow H by moving the carrier 112 itself. This serves to apply treatment continuously to a volume of soil that is substantially in the shape of a rectangular parallelepiped or that is constituted by juxtaposed rectangular parallelepipeds that are connected to one another and that correspond to the path followed by the carrier.

This embodiment is well adapted when the volume of terrain to be treated is of shallow depth. The length of the support for the endless chain must correspond to the depth of the terrain that is to be treated. To improve mixing of the terrain as it is cut up and mixing with the treatment agent, the endless chain may further include teeth or members that enhance mixing of the soil.

The gaseous treatment agents are naturally the same as those described with reference to the equipment of FIG. 1.

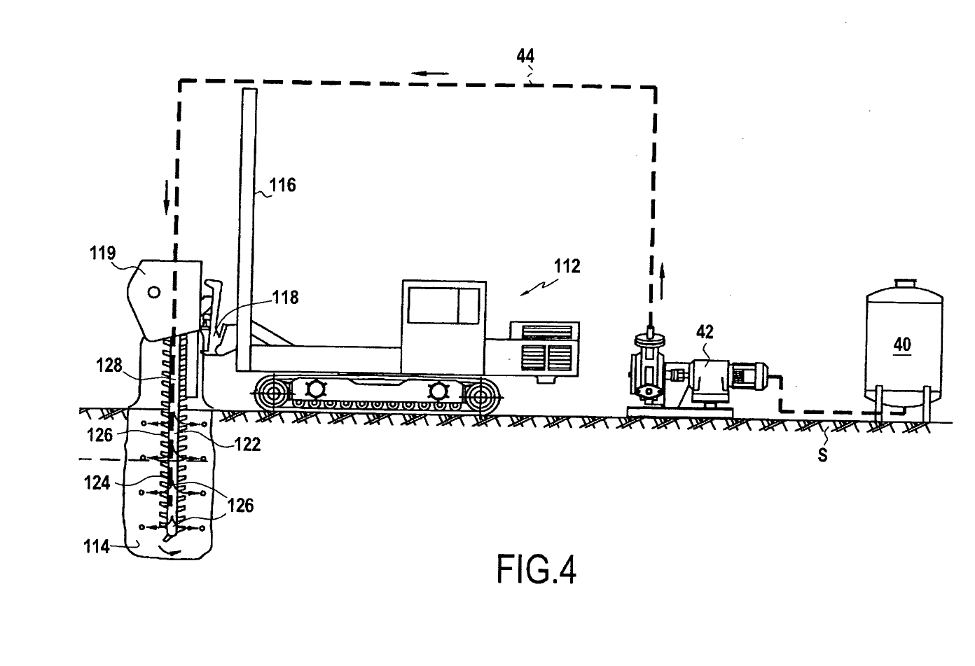

FIG. 4 shows the equipment using the cutter tool 120 when the treatment agent is a liquid. The modifications compared with the tool shown in FIG. 3 are the same as the modifications that already appear in FIG. 2. The liquid treatment agents are those already described with reference to FIG. 2.

What is claimed is:

1. A method of rehabilitating soil and/or underground water in a polluted volume of soil, the method comprising the following steps:
displacing a boring tool in said volume, the tool being suitable for cutting up the soil and mixing it uniformly in said volume; said boring tool being selected from the group comprising boring tools having a horizontal axis of rotation associated with vertical displacement, and boring tools having cutter elements that move substantially vertically, with the displacement of the tool being horizontal; and simultaneously with the mixing;
injecting a treatment agent into the soil mixed by means of said tool, such that during the mixing said treatment agent is dispersed uniformly in the volume, said treatment agent comprising at least one of the following agents suitable for acting on the polluting elements:
a gaseous fluid that is not solely chemically reactive;
a chemically reactive agent constituted by a chemical substance that is oxidizing, reducing, or neutralizing; and
a reactive agent constituted by a population of microorganisms or a microorganism culture medium;
thereby enabling the soil and/or the underground water to be rehabilitated in situ.

2. A method according to claim 1, wherein the gaseous agent that is not solely chemically reactive is constituted by air, nitrogen, or an inert gas.

3. A method according to claim 1, wherein said chemically reactive agent is gaseous, liquid, or solid.

4. A method according to claim 1, wherein the volume of soil treated is in the form of a rectangular parallelepiped or of a plurality of interconnected rectangular parallelepipeds.

5. A method according to claim 1, wherein a sealing bell is disposed over the surface of the ground in register with the zone being treated.

6. Equipment for rehabilitating soil and/or underground water in a volume of polluted soil, the equipment comprising:
a machine fitted with a boring tool for cutting into said volume of soil and mixing the soil in uniform manner within said volume, said tool further including means for injecting a treatment agent in such a manner that during the mixing said treatment agent is dispersed uniformly within the volume;
means for feeding said injection means with the treatment agent;
means for displacing said boring tool; and
sealing bell-forming means suitable for being placed on the surface of the ground in register with the soil being treated with the boring tool, said boring tool being selected from the group comprising boring tools having a horizontal axis of rotation and for moving vertically, and boring tools having cutter elements that move substantially vertically, the movement of the tool being horizontal.

7. Equipment according to claim 6, wherein the treatment agent is gaseous, and wherein said bell further includes means for extracting the gas escaping from the zone of terrain that is being treated.

8. Equipment according to claim 6, wherein said boring tool comprises two pairs of horizontal-axis rotary cutters.

9. Equipment according to claim 6, wherein said cutter element of the boring tool is a substantially vertical endless chain carrying cutter teeth.
